(19) United States
(12) Patent Application Publication
(10) Pub. No.: US 2013/0003246 A1
(43) Pub. Date: Jan. 3, 2013

(54) CONDITIONING CIRCUIT FOR AN ELECTROMAGNETIC SWITCHING DEVICE

(75) Inventor: Venkatramani Subramaniam, Mumbai (IN)

(73) Assignee: Siemens Aktiengesellschaft, Munich (DE)

(21) Appl. No.: 13/575,093

(22) PCT Filed: Feb. 8, 2010
(86) PCT No.: PCT/EP2010/051486

§ 371 Date: Aug. 30, 2012

(51) Int. Cl. H01H 47/22

(52) U.S. Cl. 361/160

(57) ABSTRACT

A circuit is disclosed for conditioning a current flowing through a coil in an electromagnetic switching device. In at least one embodiment the circuit includes an amplifier including a first amplifier terminal to receive the current flowing through the coil as an input, a second amplifier terminal to receive a second input signal and a third amplifier terminal for outputting an output signal; a diode including a first diode terminal connected to the third amplifier terminal to receive the output signal of the amplifier and a second diode terminal to provide an output, wherein the second diode terminal is connected to the second amplifier terminal to provide the output of the diode as the second input signal to the second amplifier terminal; and a filter circuit connected to the second diode terminal to filter the output of the diode.

### PRIORITY STATEMENT

This application is the national phase under 35 U.S.C. §371 of PCT International Application No. PCT/EP2010/051486 which has an International filing date of Feb. 8, 2010, which designated the United States of America, the entire contents of each of which are hereby incorporated herein by reference.

### FIELD

At least one embodiment of the invention generally relates to a circuit for conditioning a current flowing through a coil in an electromagnetic switching device.

### BACKGROUND

An electromagnetic switching device is typically used for controlling flow of electrical current in an electrical circuit. The electromagnetic switching device is controllable for switching between on and off states for closing and breaking a power supply circuit. The electromagnetic switching device may be manually or electrically controlled. To control the electromagnetic switching device electrically, magnets may be employed to actuate a movable contact element for breaking and closing the power supply circuit.

Typically, the movable contact element is moved to engagement with a stationary contact element for closing the power supply circuit. The stationary contact element is electrically connected to the power supply. Thus, the power supply circuit is closed when movable contact element is in engagement with the stationary contact element. The magnets employed to actuate the movable contact element are energized by a coil. The coil is energized by a current flowing through the coil.

### SUMMARY

At least one embodiment of the invention measures the current flowing in a coil of an electromagnetic switching device more accurately.

At least one embodiment of the invention is directed to a circuit for conditioning a current flowing through a coil in an electromagnetic switching device.

The current flowing through the coil is received by the amplifier. The output of the amplifier is provided to the diode, wherein the diode acts as a unidirectional switch to allow current to flow only in one direction. The output of the diode is provided to the filter circuit and also to the amplifier as a feedback. The feedback provided to the amplifier enables in compensating a voltage drop across the diode. This enables in obtaining a true reproduction of the current flowing through the coil at the output of the filter circuit.

### BRIEF DESCRIPTION OF THE DRAWINGS

Embodiments of the present invention are further described hereinafter with reference to illustrated embodiments shown in the accompanying drawings, in which:

FIG. 1a illustrates a carrier of an electromagnetic switching device according to an embodiment herein,

FIG. 1b illustrates an assembly of an electromagnet system and the carrier 1 of FIG. 1a according to an embodiment herein, and

FIG. 2 illustrates a schematic diagram of a system for controlling the current flowing through a coil of an electromagnetic switching device according to an embodiment herein.

Various embodiments are described with reference to the drawings, wherein like reference numerals are used to refer to like elements throughout. In the following description, for purpose of explanation, numerous specific details are set forth in order to provide a thorough understanding of one or more embodiments. It may be evident that such embodiments may be practiced without these specific details.

### DETAILED DESCRIPTION OF THE EXAMPLE EMBODIMENTS

At least one embodiment of the invention is directed to a circuit for conditioning a current flowing through a coil in an electromagnetic switching device.

The current flowing through the coil is received by the amplifier. The output of the amplifier is provided to the diode, wherein the diode acts as a unidirectional switch to allow current to flow only in one direction. The output of the diode is provided to the filter circuit and also to the amplifier as a feedback. The feedback provided to the amplifier enables in compensating a voltage drop across the diode. This enables in obtaining a true reproduction of the current flowing through the coil at the output of the filter circuit.

According to an embodiment, the filter circuit comprises a first resistor connected to the second diode terminal, a capacitor connected in series to the first resistor, and a second resistor connected in series to the first resistor and in parallel to the capacitor. The capacitor is charged by the diode via the first resistor and the capacitor discharges via the second resistor. This charging and discharging of the capacitor enables in obtaining an average value of the voltage of the signal provided to the filter circuit as an input.

According to yet another embodiment, the amplifier is an operational amplifier.

According to yet another embodiment, the first amplifier terminal is a non-inverting terminal of the operational amplifier.

According to yet another embodiment, the second amplifier terminal is an inverting terminal of the operational amplifier.

According to yet another embodiment, wherein the amplifier is a transistor.

According embodiment includes, an electromagnetic switching device comprising a circuit, wherein the electromagnetic switching device comprises a switch connected between a supply source and the coil, and a controller configured to control an on and an off state of the switch for controlling the current flowing through the coil responsive to an output of the circuit.

According to another embodiment, wherein the controller is a processor.

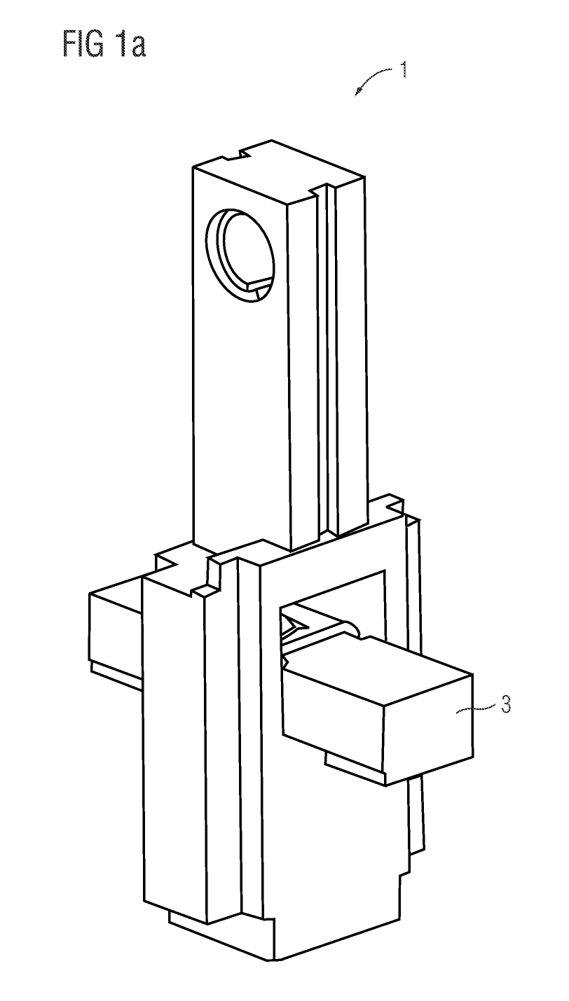

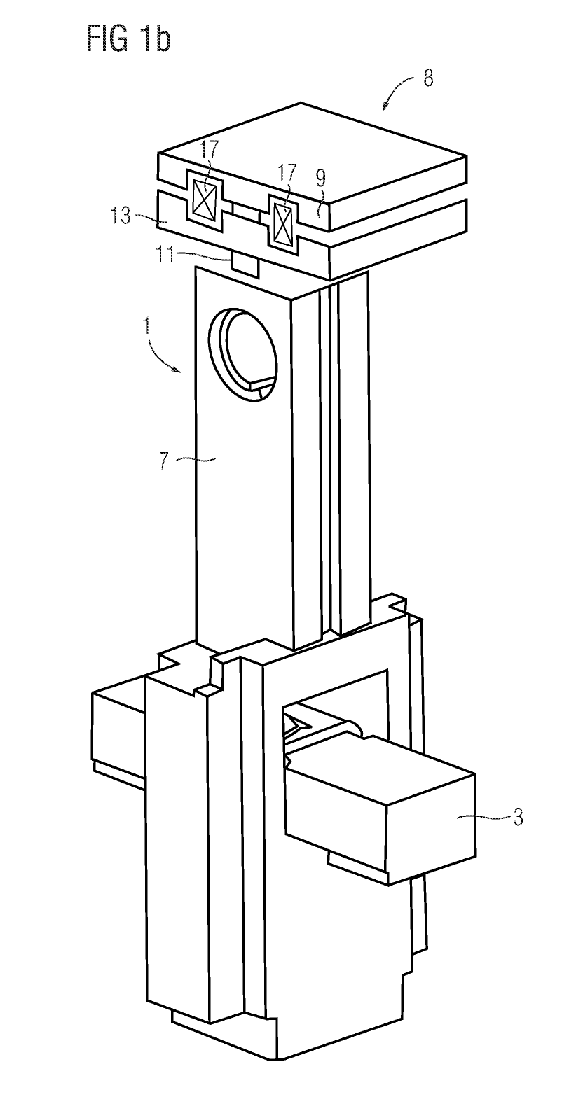

Referring to FIG. 1a, a carrier 1 of an electromagnetic switching device is illustrated according to an embodiment herein. A contact element 3 is supported in the carrier to be movable form a circuit breaking position to a circuit closing position, wherein the contact element 3 is moved to be in contact with a stationary contact element to be in the circuit closing position. The stationary contact may be connected to the input power supply.

FIG. 1b illustrates an assembly of an electromagnet system and the carrier 1 of FIG. 1a according to an embodiment herein. In the shown example of FIG. 1b, the carrier 1 comprises a column 7 extending vertically upwards. The electromagnet system 8 is supported on the column 7 to actuate the carrier. In the present embodiment, the electromagnet system 8 is shown as comprising electromagnetic armatures 9, 13. However, the electromagnet system 8 may be designed in another way comprising fewer or more electromagnetic armatures.

Typically, the electromagnetic armatures 9, 13 are adapted to actuate the carrier 1. The electromagnetic armature 9 engages the column 7 via a member 11 for transferring the armature 9 movement to the carrier 1. The carrier 1 in turn moves the contact element 3 into the circuit closing position.

In the shown example of FIG. 1b, the electromagnetic armature 9 is in engagement with the column mechanically via the member 11. However, the electromagnetic armature 9 may be engaged with the column 7 using other known mechanical means. Another electromagnetic armature 13 comprising coils 17 is also supported on the column 7.

In the shown example of FIG. 1b two coils 17 have been illustrated. However, in certain implementations the magnetic armature may comprise only a single coil 17. The coils 17 are energized by supplying a current provided by a supply source. On the coils 17 being energized, the electromagnetic armature 9 is drawn towards the electromagnetic armature 13. This movement of the armature 9 is transferred to the carrier 1 and to the contact element 3 for the circuit closing motion. However, in other embodiments, the carrier 1 may comprise a column extending vertically downwards and the electromagnetic armature 9 and the electromagnetic armature 13 may be supported on the column.

In the circuit closing motion, the contact element 3 is moved to be in contact with the stationary contact element. The contact element 3 in contact with the stationary contact element is said to be in the circuit closing position. The current required for energizing the coil 17 for the circuit closing motion of the carrier 1 and the contact element 3 is hereinafter referred to as a pick-up current. Once the contact element 3 is moved to the circuit closing position, the current required for energizing the coil 17 such that the contact element 3 is maintained at the circuit closing position is referred to as a hold-on current. Typically, the pick-up current is relatively of a very high value than the hold-on current. For example, the pick-up current required for energizing a coil is about five to ten times the hold-on current.

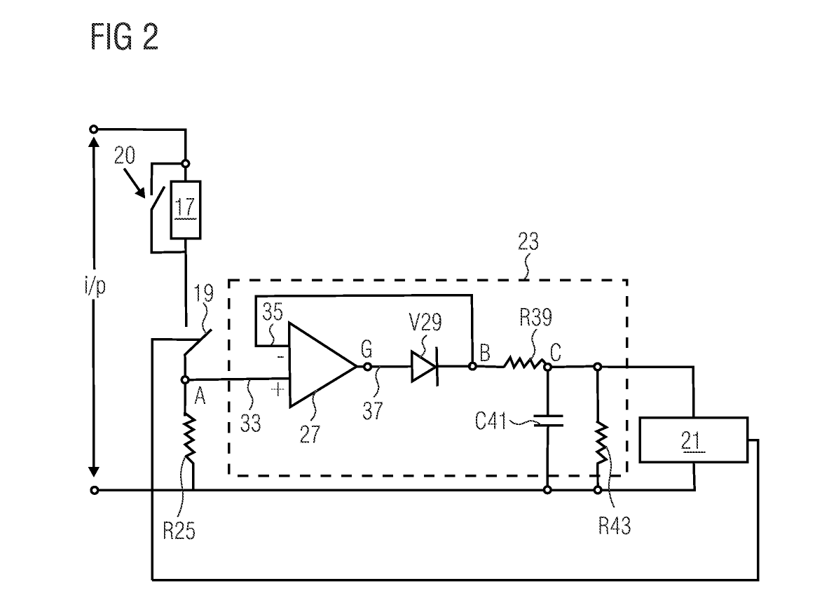

FIG. 2 illustrates a schematic diagram of a system for controlling the current flowing through the coil 17 according to an embodiment herein. In the example of FIG. 2, a current for energizing the coil 17 is provided to the coil 17 using a switch 19. The switch 19 is operable for providing the pick-up current during circuit closing motion and the hold-current for maintaining the contact element 3 of FIG. 1b at the circuit closing position. For example, the switch 19 may be a solid state static switch. A controller 21 is configured to control the switch 19 for providing the pick-up current during circuit closing motion and the hold-current for maintaining the contact element 3 at the circuit closing position. The controller 21 controls the switch 19 responsive to the current flowing in the coil 17. The current flowing in the coil 17 is provided to the controller by a conditioning circuit 23. The controller 23 may be a processor, a microcontroller, and the like. In an embodiment, a switch 20 may be connected in parallel to the coil 17. For example, the switch 20 may be operable to be in an on state during hold-on condition to circulate the hold-on current in a loop formed by the coil 17 and the switch 20. In an embodiment, the controller 21 may be configured to control the switch 19 responsive to the current flowing in the coil 17.

In an example, the conditioning circuit 23 is connected at A across a resistor R25 on the circuit providing the current to the coil 17. The conditioning circuit 23 obtains the current flowing through the coil 17 from a voltage at A. In an embodiment, the conditioning circuit 23 comprises an amplifier 27, a diode 29 and a filter circuit 31.

In the example of FIG. 2, the voltage at A is provided to the amplifier 27. The amplifier may be an operational amplifier, a transistorized circuit, and the like. In the shown example of FIG. 2, the amplifier 27 illustrated is an operational amplifier. The amplifier 21 typically comprises a first amplifier terminal 33 for receiving a first input signal, a second amplifier terminal 35 for receiving a second input signal and a third amplifier signal 37 for providing an output signal. The voltage across A is provided to the first amplifier terminal 27 as the first input signal. In an embodiment, the first amplifier terminal 33 may be a non-inverting terminal of the amplifier 27.

The third amplifier terminal 37 is connected to the diode 29. The third amplifier terminal 37 provides an output signal to a first diode terminal 30 of the diode 29 outputted by the amplifier 27. A second terminal 32 of the diode 29 is connected to the second amplifier terminal 35 and to the filter circuit 31. The output of the diode 29 is provided to the second amplifier terminal 35 as the second input signal.

In an embodiment, the second amplifier terminal 35 is an inverting terminal of the amplifier 27. The output of the diode 29 is provided to the second amplifier terminal to provide a negative feedback. The output of the diode 29 is also provided to the filter circuit 31.

As the output of the diode 29 is also provided to the amplifier 27 as a negative feedback, the amplifier 27 shall compensate the voltage drop across the diode 29 due to the closed loop gain. The output of the amplifier 27 at G is the true signal voltage at A in additional to the voltage drop of 0.7 volt of the diode 29. Thus, at point B, the true signal voltage at A is replicated.

The output voltage at B is filtered by the filter circuit 31 to obtain an average value of the voltage at C. The filter circuit 31 comprises a first resistor R39, a capacitor C41 and a second resistor R43. The first resistor R39 is connected to the second diode terminal 32. The capacitor C41 is connected in series to the first resistor R39. The second resistor R43 is connected in series to the first resistor R39 and in parallel to the capacitor C41. The diode 29 acts as a unidirectional switch and charges the capacitor 41 through the first resistor R39. The capacitor C41 discharges through the second resistor R43. This charging and discharging of the capacitor C41 enables in obtaining an average value of the voltage of the signal provided to the filter circuit 31 as an input.

The diode 29 prevents the charge on the capacitor C41 to discharge into the amplifier 27. This enables the capacitor C41 to have an independent high time constant discharge path via the second resistor R43. Thus the average value of the voltage at C outputted by the filter circuit 31 may be provided to the controller 21 for controlling the switch 19. The output of the filter circuit being a true reproduction of the signal voltage at A enables in controlling the current flowing through the coil 17 more accurately for providing the pick-up current and the hold-on current. The voltage drop across the diode 29 being compensated enables in measuring the hold-on current accurately as the hold-on current is relatively of a very low value.

The embodiments described herein enable in efficient controlling of the switch used for providing the pick-up current and the hold-on current to the coil as the controller controls the switch responsive to the actual current flowing through the coil. Moreover, as the hold-on current is relatively of a very low value, the current flowing through the coil during hold-on condition is measured accurately as the voltage drop across the diode is compensated by the amplifier. Providing a measure of the current flowing though the coil accurately to the controller enables in energizing the coil efficiently depending on the current required for circuit closing motion and maintaining of the circuit closing position.

While this invention has been described in detail with reference to certain preferred embodiments, it should be appreciated that the present invention is not limited to those precise embodiments. Rather, in view of the present disclosure which describes the current best mode for practicing the invention, many modifications and variations would present themselves, to those of skill in the art without departing from the scope and spirit of this invention. The scope of the invention is, therefore, indicated by the following claims rather than by the foregoing description. All changes, modifications, and variations coming within the meaning and range of equivalency of the claims are to be considered within their scope.

1. A circuit for conditioning a current flowing through a coil in an electromagnetic switching device, the circuit comprising:
an amplifier including a first amplifier terminal to receive current flowing through the coil as an input, a second amplifier terminal to receive a second input signal and a third amplifier terminal to output an output signal;
a diode including a first diode terminal connected to the third amplifier terminal to receive the output signal of the amplifier and a second diode terminal to provide an output, wherein the second diode terminal is connected to the second amplifier terminal to provide the output of the diode as the second input signal to the second amplifier terminal; and
a filter circuit connected to the second diode terminal to filter the output of the diode.

2. The circuit of claim 1, wherein the filter circuit comprises a first resistor connected to the second diode terminal, a capacitor connected in series to the first resistor, and a second resistor connected in series to the first resistor and in parallel to the capacitor.

3. The circuit of claim 1, wherein the amplifier is an operational amplifier.

4. The circuit according to claim 3, wherein the first amplifier terminal is a non-inverting terminal of the operational amplifier.

5. The circuit according to claim 3, wherein the second amplifier terminal is an inverting terminal of the operational amplifier.

6. The circuit of claim 1, wherein the amplifier is a transistor.

7. An electromagnetic switching device comprising:
the circuit of claim 1;
a switch connected between a supply source and the coil; and
a controller configured to control an on and an off state of the switch for controlling the current flowing through the coil responsive to an output of the circuit.

8. The electromagnetic switching device of claim 7, wherein the controller is a processor.

9. The circuit of claim 2, wherein the amplifier is an operational amplifier.

10. The circuit according to claim 9, wherein the first amplifier terminal is a non-inverting terminal of the operational amplifier.

11. The circuit according to claim 9, wherein the second amplifier terminal is an inverting terminal of the operational amplifier.
